(19) United States
(12) Patent Application Publication
(10) Pub. No.: US 2016/0082923 A1
(43) Pub. Date: Mar. 24, 2016

(54) AN ALARM SYSTEM

(71) Applicant: Bar GAVRIEL, Melbourne (AU)

(72) Inventor: Bar GAVRIEL, Melbourne (AU)

(21) Appl. No.: 14/785,378

(22) PCT Filed: Apr. 20, 2014
(86) PCT No.: PCT/AU2014/000456

§ 371 Date: Oct. 19, 2015

(30) Foreign Application Priority Data
Apr. 19, 2013 (AU) 2013100548

(51) Int. Cl. B60R 22/48

(52) U.S. Cl. CPC B60R 22/48; B60R 2022/4808

(57) ABSTRACT

An alarm system fox a vehicle, comprising a, trigger monitor in communication, with a trigger sensor and a safety belt sensor, the trigger monitor arranged to receive from the safety belt sensor a safety belt signal indicating that a safety belt in the vehicle is retained by a corresponding safety belt retainer; and upon receipt of the safety belt signal, monitor the trigger sensor to determine whether or not a trigger condition is met with respect to the trigger sensor; and an alarm generator in communication with the trigger monitor, the alarm generator arranged to generate an alarm signal upon a determination by the trigger monitor that the trigger condition is met.

Priority is claimed from Australian parent application/patent AU 2013100548 the entire contents of which is incorporated herein by reference.

### FIELD

The present invention relates to an alarm system and a method of generating an alarm signal.

### BACKGROUND

It is dangerous to leave young children unattended in cars. As temperatures in cars can rise rapidly, children left unattended in cars may suffer from heat stress and dehydration in a short amount of time which can lead to serious medical consequences including death. A similar problem arises with disabled people and pets becoming trapped in vehicles, particularly group transport vehicles such as buses and the like. Thus, there is a need to provide a system for detecting unattended children in cars, but also a system for detecting people in general, and/or pets, who are trapped in a vehicle.

### SUMMARY OF THE INVENTION

The description that follows predominantly focuses on the application of the present invention for the detection of infants in vehicles. This focus is for illustration purposes only. The present teachings can be similarly applied to the detection of other people, such as the disabled, or pets. To that extent, except where context indicates otherwise recitations of the terms “infant”, “baby” and similar can be substituted for “person”, “disabled person”, “pet” and analogous terms and their respective plurals, and the disclosure is intended to capture within its scope the application of the invention to the detection of all such people and pets.

The present invention provides an alarm system for a vehicle, comprising:

a trigger monitor in communication with a trigger sensor and a safety belt sensor, the trigger monitor arranged to:
receive from the safety belt sensor a safety belt signal indicating that a safety belt in the vehicle is retained by a corresponding safety belt retainer; and
upon receipt of the safety belt signal, monitor the trigger sensor to determine whether or not a trigger condition is met with respect to the trigger sensor; and

an alarm generator in communication with the trigger monitor, the alarm generator arranged to generate an alarm signal upon a determination by the trigger monitor that the trigger condition is met,

wherein the safety belt sensor is connected to an electronics system of the vehicle.

In an embodiment, the alarm generator is in communication with the safety belt sensor, and is arranged to:

upon a determination by the trigger monitor that the trigger condition is met, determine whether or not the safety belt is still retained by the safety belt retainer using the safety belt sensor; and

generate an alarm signal only upon a determination that the safety belt is still retained by the corresponding safety belt retainer.

The present invention also provides an alarm system for a vehicle, comprising:

a trigger monitor operable to monitor a trigger sensor to determine whether or not a trigger condition is met with respect to the trigger sensor; and

an alarm generator operable to generate an alarm signal;

the alarm system arranged to:
cause the trigger monitor to monitor the trigger sensor to determine whether or not the trigger condition is met with respect to the trigger sensor;
upon a determination by the trigger monitor that the trigger condition is met, determine using a safety belt sensor whether or not a safety belt in the vehicle is retained by a corresponding safety belt retainer; and
cause the alarm generator to generate an alarm signal upon a determination that the safety belt is retained by the corresponding safety belt retainer,
   wherein the safety belt sensor is connected to an electronics system of the vehicle.

In an embodiment, the trigger sensor comprises a thermometer for measuring a temperature within the vehicle.

In an embodiment, the trigger condition with respect to the thermometer is that the temperature measured by the thermometer is greater than a temperature threshold.

In an embodiment, the trigger condition with respect to the thermometer is that the temperature measured by the thermometer is less than a temperature threshold.

In an embodiment, the trigger condition with respect to the thermometer is that the temperature measured by the thermometer is not within a temperature range.

In an embodiment, the trigger monitor is in communication with a motor of the vehicle, and is arranged to

determine whether or not the motor is switched off; and

monitor the trigger sensor only upon a determination that the motor is switched off.

In an embodiment, the trigger sensor comprises a vibration sensor for measuring a vibration level within the vehicle, and the trigger condition with respect to the vibration sensor is that the vibration level measured by the vibration sensor is greater than a vibration level threshold.

In an embodiment, the vibration sensor is attached to an infant carrier within the vehicle.

In an embodiment, the vibration sensor is mounted in the safety belt retainer.

In an embodiment, the trigger sensor comprises both a vibration sensor and at least one other sensor for monitoring for a further trigger condition, and the trigger monitor monitors for both a trigger condition with respect to the vibration sensor and the further trigger condition to be met before causing the alarm generator to generate the alarm signal.

In an embodiment, the trigger sensor comprises a motion detector for detecting a motion within the vehicle, and the trigger condition with respect to the motion sensor is that motion is detected by the motion detector.

In an embodiment, the motion detector is an infrared sensor.

In an embodiment, the trigger sensor comprises a pressure sensor for detecting a weight on a seat of the vehicle, and the trigger condition with respect to the pressure sensor is that a weight is detected on the seat.

In an embodiment, the trigger sensor comprises a microphone in the vehicle, and the trigger condition with respect to the microphone is that a sound received by the microphone is greater than a sound threshold level.

In an embodiment, the trigger sensor comprises an audio sensor for detecting a sound having an acoustic signature of an infant, and the trigger condition with respect to the audio sensor is that a sound having an acoustic signature of an infant is detected by the audio sensor.

In an embodiment, the trigger sensor comprises an object detector for detecting the presence of an object within an infant carrier in the vehicle, and the trigger condition with respect to the object detector is that the presence of an object within the infant carrier is detected by the object detector.

In an embodiment, the object detector comprises an electromagnetic radiation emitter for emitting electromagnetic radiation directed towards the infant carrier, and an electromagnetic radiation detector for detecting the electromagnetic radiation emitted from the an electromagnetic radiation emitter, and wherein the object detector detects the presence of an object within the infant carrier when electromagnetic radiation emitted from the electromagnetic radiation emitter towards the infant carrier is not detected by the electromagnetic radiation the detector.

In an embodiment, the system further comprises a power supply for supplying power to the trigger monitor and the alarm generator upon a determination that the motor of the vehicle is switched off.

In an embodiment, the alarm generator is in communication with at least one response device of the vehicle.

In an embodiment, the at least one response device comprises a radio device, and the system is arranged to control the radio device to transmit a radio signal to a remote device.

In an embodiment, the remote device is arranged to sound an audible alarm upon receipt of the radio signal from the radio device.

In an embodiment, the remote device is arranged to:

receive a user input; and

transmit a response signal to the radio device.

In an embodiment, the at least one response device comprises an air conditioning system of the vehicle, and the system is arranged to switch on the air conditioning system upon receipt of the response signal from the radio device.

In an embodiment, the at least one response device comprises a horn of the vehicle, and the system is arranged to sound the horn upon receipt of the response signal from the remote device.

In an embodiment, the at least one response device comprises a display, and the system is arranged to control the display to display a visual warning upon receipt of the response signal from the remote device.

In an embodiment, the at least one response device comprises a security system of the vehicle, and the system is arranged to control the security system to sound an audible alarm upon receipt of the response signal from the remote device.

In an embodiment, the at least one response device comprises a window controller of the vehicle, and the system is arranged to control the window controller to roll down a window of the vehicle upon receipt of the response signal from the remote device.

In an embodiment, the at least one response device comprises a door of the vehicle, and the system is arranged to unlock the door upon receipt of the response signal from the remote device.

In an embodiment, the remote device is a vehicle remote control.

In an embodiment, the remote device is a keychain or key ring mounted alarm device.

In an embodiment, the remote device is a cellular phone.

In an embodiment, when the remote device is a cellular phone the audible alarm comprises a notification of at least one of: receipt of an incoming message; and an incoming phone call.

In an embodiment, the incoming message or incoming phone call comprises a pre-recorded message to alert the operator of the cellular phone that there is a trapped vehicle occupant.

In an embodiment, the operator of the cellular phone can deactivate the alarm generator by responding to the radio signal.

In an embodiment, the remote device is a rescue centre receiver and the radio signal is for informating a rescue centre via the rescue centre receiver that an occupant is trapped in a vehicle.

In an embodiment, the radio signal sent to the rescue centre receiver comprises GPS coordinates of the vehicle.

In an embodiment, the GPS coordinates are taken from a GPS unit in the vehicle.

In an embodiment, the system further comprises a power supply for supplying power to the GPS unit in the vehicle and the alarm generator upon a determination that the motor of the vehicle is switched off.

In an embodiment, the system stores vehicle identification information.

In an embodiment, the radio signal sent to the rescue centre receiver comprises the vehicle identification information.

In an embodiment, the safety belt and the corresponding safety belt retainer are part of an infant carrier in the vehicle.

In an embodiment, the safety belt and the corresponding safety belt retainer are part of a child seat in the vehicle.

In an embodiment, the system further comprises the trigger sensor.

The invention also provides a vehicle comprising the above alarm system.

The invention also provides a method of generating an alarm signal for a vehicle, the method comprising:

receiving from a safety belt sensor a safety belt signal indicating that a safety belt in the vehicle is retained by a corresponding safety belt retainer;

upon receipt of the safety belt signal, monitoring a trigger sensor to determine whether or not a trigger condition is met with respect to the trigger sensor; and

generating an alarm signal upon a determination that the trigger condition is met,

wherein the safety belt sensor is connected to an electronics system of the vehicle.

In an embodiment, the method further comprises:

upon a determination that the trigger condition is met, determining whether or not the safety belt is still retained by the safety belt retainer,

wherein the alarm signal is generated only upon a determination that the safety belt is still retained by the safety belt retainer

The invention also provides a method of generating an alarm for a vehicle, the method comprising:

monitoring a trigger sensor to determine whether or not a trigger condition is met with respect to a trigger sensor; and

upon a determination by the trigger monitor that the trigger condition is met, determining using a safety belt sensor whether or not a safety belt in the vehicle is retained by a corresponding safety belt retainer; and

generating an alarm signal upon a determination that the safety belt is retained by the corresponding safety belt retainer,

wherein the safety belt sensor is connected to an electronics system of the vehicle.

In an embodiment, the method further comprises:

determining whether or not a motor of the vehicle is switched off,

wherein the trigger sensor is monitored only upon a determination that the motor is switched off.

In an embodiment, the method further comprises: supplying power to the trigger monitor and the alarm generator upon a determination that the motor is switched off.

In an embodiment, the method further comprises:

transmitting a radio signal to a remote device;

receiving from the remote device a response signal to the radio signal; and

controlling at least one response device upon receipt of the response signal from the remote device.

### BRIEF DESCRIPTION OF THE DRAWINGS

In order that the invention may be more clearly ascertained, embodiments will now be described, by way of example, with reference to the accompanying drawings, in which:

FIG. 1 is a schematic diagram of the alarm system according to an embodiment of the invention;

FIG. 2 is another schematic diagram of the alarm system of FIG. 1;

FIG. 3 is a schematic diagram of the functional components of the alarm system of FIG. 1;

FIG. 4 is a schematic diagram of the alarm system according to another embodiment of the invention; and

FIG. 5 is a schematic diagram of the alarm system according to another embodiment of the invention is a flow chart of a method of generating an alarm signal, carried out using the alarm system of FIGS. 1 to 3.

### DETAILED DESCRIPTION

Referring to the drawings, there is illustrated an embodiment of an alarm system 18 for a vehicle 6. The alarm system 18 comprises a trigger monitor 183 and an alarm generator 188 in communication with the trigger monitor 183. The trigger monitor 183 is operable to monitor a trigger sensor 28 (such as a motion detector in the form of a passive infrared detector) to determine whether or not a trigger condition is met with respect to the trigger sensor 28. The alarm generator 188 is operable to generate an alarm signal when the alarm system 18 determines that (i) a safety belt in the vehicle is retained by a corresponding safety belt retainer in the vehicle and (ii) the trigger condition is met with respect to the trigger sensor 28. Advantageously, the embodiment of the alarm system 18 does not generate an alarm signal when the safety belt is not retained by the corresponding safety belt retainer. This prevents the alarm system 18 from unnecessarily generating an alarm signal when the safety belt is not in use (such as when there is no one in the vehicle).

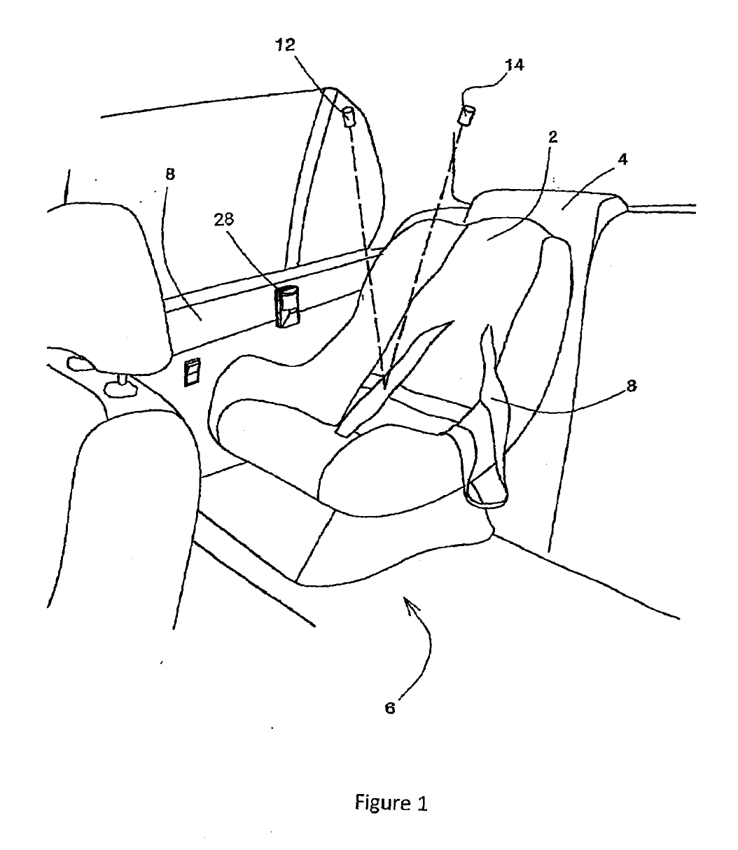

Referring FIG. 1, there is illustrated a schematic diagram of an embodiment of the alarm system 18 for a vehicle in the form of a family car. As shown in FIG. 1, the car 6 has a child booster seat 2 disposed on a back seat 4 of the car 6. The child booster seat 2 is not permanently fixed to the back seat 4. That is, the child booster seat 2 is only temporarily secured to the vehicle by a safety belt (not shown) and a corresponding safety belt retainer (also not shown) of the car 6. A safety belt sensor (not shown) is provided in the car 6. Persons skilled in the art will appreciate that the safety belt typically comprises a sash and tongue, and the safety belt retainer typically comprises a buckle, such that the sash and tongue can engaged with the buckle to retain the sash and tongue in place. Persons skilled in the art will appreciate that the safety belt may be one of a pair of sashes and tongues (for example, those typically found in child booster seats or infant carriers), and the safety belt retainer may be a buckle that is arranged to receive both sashes and tongues. In this embodiment, the safety belt is a seat belt for the car 6. However, persons skilled in the art will appreciate that the safety belt may not be a seat belt for a car. For example, the safety belt may be a safety belt of an infant carrier.

The safety belt sensor is arranged to detect whether or not the safety belt is retained by the corresponding safety belt retainer. If the safety belt is retained by the corresponding safety belt retainer, the safety belt outputs a safety belt signal indicating that the safety belt is retained by the corresponding safety belt retainer. The alarm system 18 is arranged to generate an alarm signal when the alarm system 18 determines that the safety belt is retained by the corresponding safety belt retainer.

In this embodiment, the safety belt, the corresponding safety belt retainer and the safety belt sensor are built or integrated into the car, such that the safety belt, the corresponding safety belt retainer and the safety belt sensor are part of the car. However, persons skilled in the art will appreciate that the safety belt, safety belt retainer and safety belt sensor may alternatively be built into a car booster seat or an infant carrier, and thus may not be integrated with or part of the car. For example, FIG. 1 also illustrates that the child boaster seat 2 has child safety belts for strapping a child to the child booster seat 2. In this embodiment, these child safety belts are not part of the alarm system 18. However, in an alternative embodiment of the alarm system 18, these child safety belts may be part of the alarm system 18 such that detection of the presence of a child left unattended (or left alone or without supervision) in the child booster seat 2 by the alternative embodiment of the alarm system 18 may involve determining whether or not these child safety belts are retained by corresponding child safety belt retainers.

As indicated above, the alarm system 18 is operable to monitor a trigger sensor 28 to determine whether or not a trigger condition is met with respect to the trigger sensor 28. In this embodiment, the trigger sensor 28 comprises a motion detector in the form of a passive infrared detector which is operable to detect the presence of a child in the child booster seat 2, and the trigger condition with respect to the passive infrared detector 28 is that the presence of a child in the child booster seat 2 is detected by the passive infrared detector 28.

The passive infrared detector 28 is similar to the passive infrared detectors commonly found in burglar alarms for homes. The passive infrared detector 28 comprises a broken parabolic mirror mounted behind a solid state infrared sensor. The passive infrared detector 28 is affixed to a back seat door 18 of the car 6 such that radiation emanating from a child seated in the child booster seat 2 is incident on the sensor. The passive infrared detector 28 is configured to detect the movements of a child in the child booster seat 2. It is envisaged that this may include even slight movements such as those of a sleeping child. Thus, the passive infrared detector 28 is capable of detecting the presence of a child left unattended in the child booster seat 2 so long as radiation emanating from the child is incident on the sensor.

It is envisaged that an alternative embodiment of the alarm system 18 may include a trigger sensor 28 comprising not only a passive infrared detector, but also other sensors or detectors. For example, as illustrated in FIG. 1, the trigger sensor may also additionally comprise an object detector in the form of an active emitter detector pair 12, 14. The emitter 12 is operable to emit electromagnetic radiation. The detector 14 is operable to detect the electromagnetic radiation emitted by the emitter 12. The emitter detector pair is operable to detect the presence of a child in the child booster seat 2 when radiation emitted from emitter 12 is reflected off the child and detected by detector 14. In this respect, the emitter detector pair may be alternatively configured with a reflective patch within the child booster and arranged to reflect radiation emitted from emitter 12 to the detector 14, such that the emitter detector pair detects the presence of a child in the child booster seat 2 only when electromagnetic radiation emitted from the electromagnetic radiation emitter 12 towards the reflective patch is not detected by the electromagnetic radiation the detector 14. Advantageously, the emitter detector pair 12, 14 can be arranged to detect only the presence of a child in the child booster seat 2, and not other people or objects in the car 6.

It is also envisaged that the trigger sensor may not include alternative types of detectors (or sensors) or a combination of sensors. Examples of such other detectors include a thermometer, a vibration sensor, an audio sensor and a weight sensor. The thermometer may be integrated of part of the thermostat of the car electronics system 13 or air conditioning system 38. The vibration sensor may be mounted on the child booster seat 2 and operable to detect the presence of a child upon detecting a vibration caused by a child in the child booster seat 2. The vibration sensor may be mounted in the safety belt retainer or buckle, so that vibrations such as pulling of the safety belt are sensed by the vibration sensor: such a vibration sensor may comprise a solenoid and solenoid switch where pulling on the safety belt results in a changes electromagnetic field produced by the solenoid, thus changing the current through the solenoid and thereby activating the switch. Such a vibration sensor may also comprise a strain gauge. The audio sensor may be operable to detect the audio signature of a crying child or a barking dog in the car. The weight or pressure sensor may be mounted in a back seat 4 of the car 6 and operable to detect the presence of a child upon detecting the child sitting on the back seat 4.

In this embodiment, the alarm system 18 is integrated with or into the car electronics system 13 of the car, and is connected to the battery 55 of the car. However, it is envisaged that an alternative embodiment of the alarm system 18 may not be integrated with the car electronics system 13 of the car, and may additionally or alternatively include a dedicated power supply or battery for supplying power to the alarm system 18. Depending on the embodiment, such a power supply or battery may supply power only at certain times (for example, in an embodiment where the alarm system 18 is integrated with the car electronics system 13 and includes a dedicated power battery, the power supply or battery may supply power only upon a determination that the motor 33 of the car 6 is switched off), or constantly (for example, in an embodiment where the alarm system 18 is not integrated with the car electronics system 13).

Persons skilled in the art will appreciate that an alternative embodiment may additionally or alternatively be used to detect the presence of an infant, a handicapped person, a pet etc. Persons skilled in the art will also appreciate that the alarm system 18 may alternatively be used with a car 6 having an infant carrier, for example, to detect the presence of an infant in the infant carrier. Persons skilled in the art will also appreciate that the alarm system 18 may alternatively be used in a car 6 without a child booster seat or infant carrier, for example, to detect the presence of a handicapped person seated in the car.

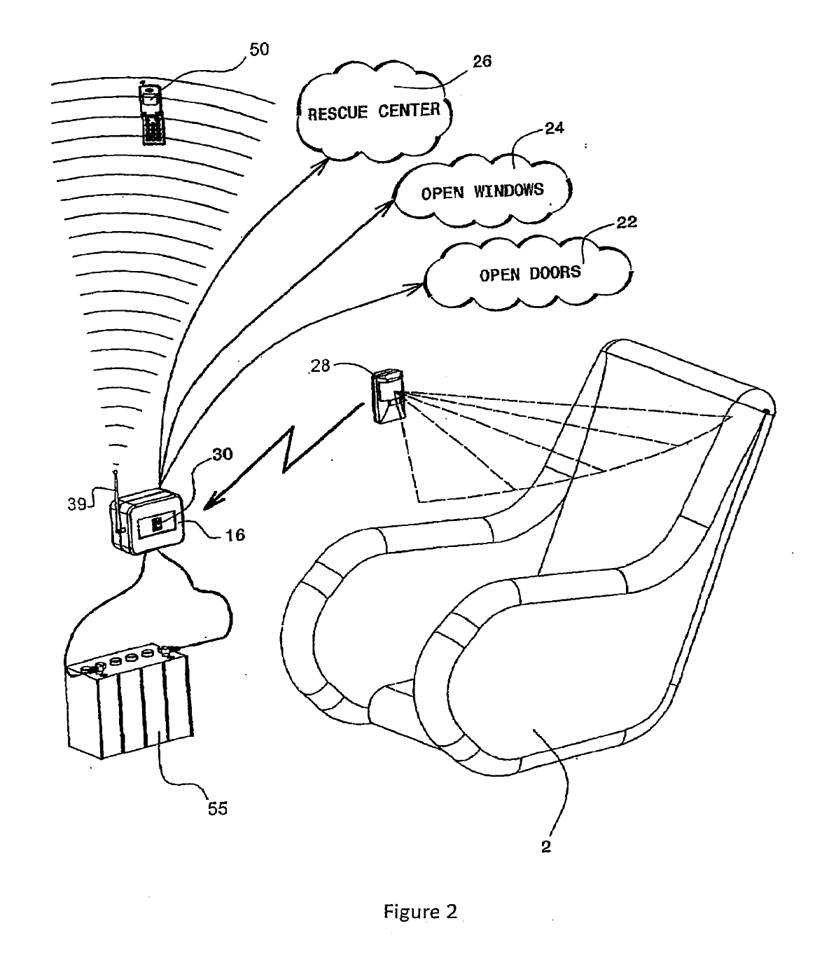

FIG. 2 is another schematic diagram of the embodiment of the alarm system 18 of FIG. 1. As illustrated in FIG. 2, the alarm system 18 is in communication with a response device 16 in addition to the trigger sensor 28. The alarm system 18 is arranged to output an alarm signal to the response device 16 to control the response device 16 to generate an alarm or a warning. The response device 16 of this embodiment includes a transceiver 20 operable to transmit a radio signal to a remote device (in the form of a mobile phone 50) and a rescue center 26 (such as a police station, a fire station, or an emergency towing and car repair service). The transceiver 20 is also arranged to receive a radio response signal from the mobile phone 50 or the rescue center 26.

It is envisaged that the remote device may also be a car remote control, such as may be used to lock/unlock a car (e.g. if the car is remotely locked and the system determines an occupant remains in the car, the alarm generator may be immediately activated), or a keychain or key ring mounted alarm device.

To transmit a radio signal to a rescue centre 26 will typically involve transmitting a radio signal to a rescue centre receiver (not shown). The radio signal would inform the rescue centre 26 via the rescue centre receiver that an occupant is trapped in the vehicle. To assist locating the vehicle, the radio signal may comprise GPS coordinates of the vehicle where the GPS coordinates are taken from a GPS unit of the vehicle or a GPS unit that forms part of the alarm system 18. In the case where GPS coordinates are taken from a GPS unit of the vehicle, the GPS unit will typically lose power once the car motor 33 is switched off. Consequently, the alarm system 18 would require a power supply for supplying power to the GPS unit in the vehicle (or alarm system 18 as the case may be) once the motor 33 is switched off. This power unit could be the same power unit that powers the system 18.

Where the vehicle is parked in a parking lot, particularly a multilevel parking lot, GPS coordinates may not give a sufficiently accurate location of the vehicle to enable its timely location. To facilitate swift identification of the vehicle the system 18 may include a memory for storing vehicle identification information (e.g. licence plate, car make and model): the radio signal sent to the rescue centre receiver of the rescue centre 26 would then comprise the vehicle identification information.

In this embodiment, the response device 16 is part of the car electronics system 13 of the car, and is arranged to control the central locking system 39 of the car 6 to unlock one or more of the doors 8 of the car 6 and/or to control a controller of the car 6 to wind down (or wind up) one or more windows of the car. Depending on the embodiment, the response device 16 may perform such control upon receipt of an alarm signal from the alarm system 18 or only upon receipt of a radio response signal from the mobile phone 50 or the rescue center 26. The radio response signal may also be able to deactivate the alarm generator, for example, if a user of the mobile phone 50 knows there is no trapped vehicle occupant.

The response device 16 also includes a button 30 for switching the response device 16 on or off. In an alternative embodiment, the response device 16 may include an input device other than the button 30. For example, in an embodiment where the trigger sensor 28 comprises multiple sensors and/or the response device 16 comprises multiple devices for generating an alarm, the response device 16 may include a touchscreen arranged to enable a user to switch on or off one or more of the multiple sensors and/or multiple devices. In this embodiment, the response device 16 is coupled to the battery 55 of the car 6. However, it is envisaged that the response device 16 may alternatively or additionally include a dedicated power supply.

It is envisaged that the response device 16 may include or be in communication with other devices for generating an alarm or a warning. For example, the response device 16 of an alternative embodiment may additionally comprise an amplifier and a speaker operable to generate an audible alarm when the alarm system 18 detects the presence of a child left unattended in the car. In the case where a radio signal is forwarded to mobile phone 50, the audible alarm may comprises a notification of at least one of: receipt of an incoming message (e.g. an SMS or MMS); and an incoming phone call. In such cases, the incoming message or incoming phase call could include a pre-recorded message to alert the operator of the mobile phone 50 that there is a trapped vehicle occupant.

An alternative embodiment may additionally or alternatively involve the car horn or an external speaker in communication with the response device 16, such that the response device 16 may sound the car horn or output an audible alarm from the external speaker when the alarm system 18 detects the presence of a child left unattended in the car.

Also, it is envisaged that an alternative embodiment of the alarm system 18 may include a response device 16 that is operable to generate an alarm other than an audible alarm or a radio signal. For example, the response device 16 may additionally or alternatively comprise a display and be operable to generate an alarm in the form of a visual alarm on the display (for example, as a backup in case the audible alarm fails to work, to alert passer bys if the car 6 is left in busy thoroughfare, to alert people with hearing difficulties etc). Examples of such a display may include any exterior lighting device of the car 6 including one or more of the headlamps of the vehicle. It is also envisaged that the display may be a dedicated lighting device for displaying the visual alarm. Thus, it will be appreciated that the response device 16 need not always include the transceiver 39.

As indicated above, the response device 16 is part of the car electronics system 13. However, it is envisaged that the response device 16 of an alternative embodiment may not be part of or integrated with the car electronics system 13. Also, it is envisaged that the response device 16 may alternatively be integrated with or be comprised in the alarm system 18.

The alarm system 18 comprises a number of functional components for generating the alarm signal for the car. It is envisaged that the functional components are typically implemented by a processor of the alarm system 18 executing program code and data stored in a memory of the system 18. However, persons skilled in the art will appreciate that this need not be the case. For example, one or more of the components could be implemented in an alternative manner, for example, as a dedicated circuit.

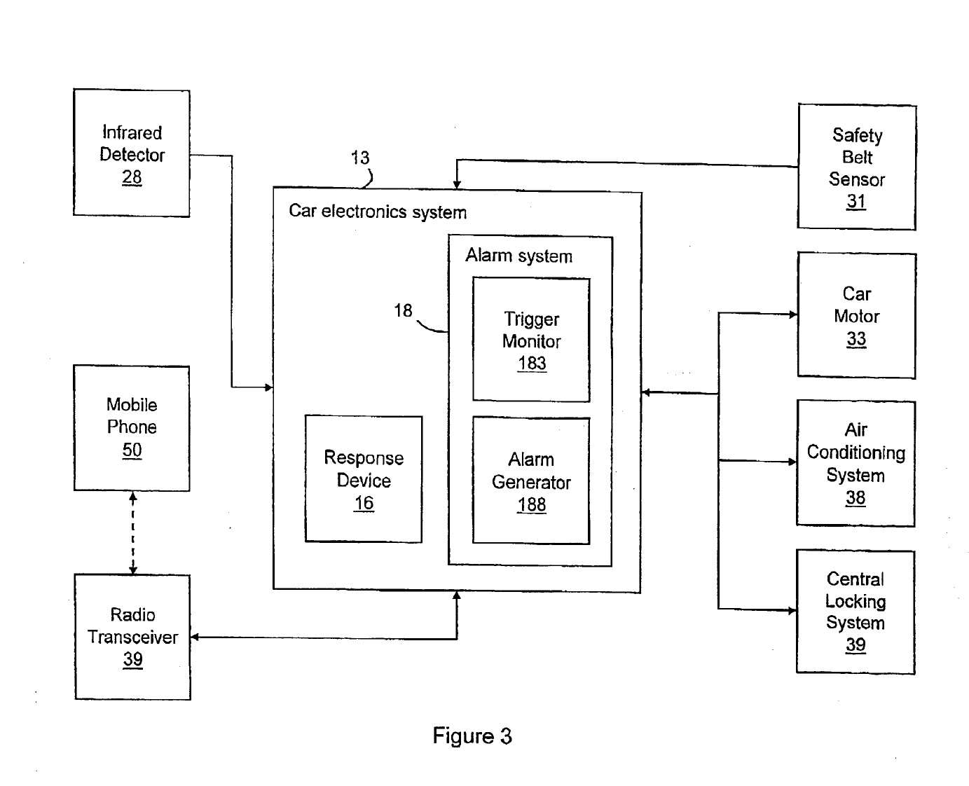

FIG. 3 is a schematic diagram showing the functional components of the alarm system 18. As illustrated, the alarm system 18 is integrated with the electronics system 13 of the car 6 which is connected to the safety sensor 31, a motor 33 of the car 6 and the air conditioning system 38 of the car 6.

One of the functional components is a trigger monitor 183. The trigger monitor 183 is in communication with the trigger sensor (that is, the passive infrared detector 28). The trigger monitor 183 is arranged to receive from the safety belt sensor 31 a safety belt signal indicating that the safety belt in the car 6 is retained by the corresponding safety belt retainer. Thus, the trigger monitor 183 determines that the safety belt is retained by the corresponding safety belt retainer when the trigger monitor 183 receives the safety belt signal from the to safety belt sensor 31. The trigger monitor 183 is also arranged to determine whether or not the motor is switched off upon receipt of the safety belt signal, and to monitor the passive infrared detector 28 to determine whether or not a trigger condition is met with respect to the passive infrared detector 28 upon a determination that the motor is switched off. In this embodiment, the trigger monitor 183 monitors the passive infrared detector 28 only when (i) the safety belt is retained by the safety belt retainer and (ii) the motor 33 is switched off. However, it is envisaged that the trigger monitor 183 of an alternative embodiment of the alarm system 18 may monitor the passive infrared sensor 28 irrespective of whether or not the safety belt is retained by the corresponding safety belt and/or irrespective of whether or not the motor 33 is switched off.

As indicated above, the trigger monitor 183 monitors the passive infrared detector 28 to determine whether a trigger condition is met with respect to the passive infrared detector 28, and the trigger condition with respect to the passive infrared detector 28 is that radiation is detected by the passive infrared detector 28. Thus, the passive infrared detector 28 determines that the trigger condition is met when the passive infrared detector 28 detects radiation emanating from a child seated in the child booster seat 2.

It will be appreciated that the trigger condition is different in alternative embodiments involving other types of trigger sensors. For example, in an alternative embodiment where the trigger sensor comprises a thermometer for measuring a temperature within the vehicle, the trigger condition with respect to the thermometer may be that the temperature measured by the thermometer is greater than a temperature threshold, that the temperature measured by the thermometer is less than a temperature threshold, be not within a temperature range, or be within a temperature range. In an alternative embodiment where the trigger sensor comprises a vibration sensor for measuring a vibration level within the vehicle, the trigger condition with respect to the vibration sensor may be that the vibration level measured by the vibration sensor is greater than a vibration level threshold. As indicated above, such a vibration sensor may be attached to the child booster seat (or an infant carrier) within the vehicle. As also indicated above, the vibration sensor may be mounted in the safety belt retainer or buckle. Such a vibration sensor may comprise a solenoid and solenoid switch or a strain gauge, or any other appropriate sensor. In the case of a solenoid or strain gauge, vibration will be determined by responses of the solenoid or strain gauge to changes in the relative spacing between two portions of the safety belt retainer or buckle, or between a portion of the safety belt retainer and a portion of the safety belt.

Where the trigger sensor comprises a vibration sensor it may also comprise a further trigger sensor such as a temperature sensor. Thus the trigger monitor may monitor for a trigger condition to be met in respect of both the vibration sensor and further trigger sensor wherein, for example, upon a vibration level threshold being reach the trigger monitor will determine whether a temperature threshold has also been reached. If the temperature threshold has not been reached then the occupant may be deemed safe and the trigger monitor will not cause the alarm generator to generate an alarm signal. If both vibration and temperature trigger conditions are met, then the trigger monitor causes the alarm generator to generate an alarm signal.

In an alternative embodiment where the trigger sensor comprises a weight or pressure sensor for detecting a weight on a seat of the vehicle, the trigger condition with respect to the pressure sensor may be that a weight is detected on the seat. In an alternative embodiment where the trigger sensor comprises a microphone in the vehicle, the trigger condition with respect to the microphone may be that a sound received by the microphone is greater than a sound threshold level. In an alternative embodiment where the trigger sensor comprises an audio sensor for detecting a sound having an acoustic signature of an infant, the trigger condition with respect to the audio sensor may be that a sound having an acoustic signature of an infant is detected by the audio sensor. In an alternative embodiment where the trigger sensor comprises an object detector for detecting the presence of an object within an infant carrier in the vehicle, the trigger condition with respect to the object detector may be that the presence of an object within the infant carrier is detected by the object detector.

The alarm system 18 also comprises an alarm generator 188 in communication with the trigger monitor 183 and the safety belt sensor 31. The alarm generator 188 is arranged to determine using the safety belt sensor 31 whether or not the safety belt is still retained by the safety belt retainer upon a determination by the trigger monitor 183 that the trigger condition is met, and to generate an alarm signal upon a determination by the safety belt sensor 31 that the safety belt is still retained by the corresponding safety belt retainer. That is, the alarm generator 188 determines using the safety belt sensor 31 whether or not the safety belt is still retained by the safety belt retainer when the passive infrared sensor 28 detects the presence of a child left unattended in the child booster seat, and generates an alarm signal upon a determination by the safety belt sensor 31 that the safety belt is still retained by the corresponding safety belt retainer.

The alarm generator 188 determines using the safety belt sensor 31 whether or not the safety belt is still retained by the safety belt retainer by checking the safety belt sensor 31 to determine whether or not the alarm system 18 is still receiving the safety belt signal from the safety belt sensor. It is envisaged that the alarm generator 188 of an alternative embodiment of the alarm system 18 may not be arranged to determine whether or not the safety belt is still retained by the safety belt retainer. Thus, the alarm generator 188 of an alternative embodiment of the alarm system 18 may generate an alarm signal upon a determination by the trigger monitor 183 that the trigger condition is met without a determination by the safety belt sensor 31 that the safety belt is still retained by the corresponding safety belt retainer.

As indicated above, the alarm signal generated by the alarm generator 188 is output to the response device 16 to cause the transceiver 39 to transmit a radio signal. As indicated above, the alarm signal generated by the alarm generator 188 may alternatively or additionally be output to another device or devices in an embodiment where the response device 16 involves another device or devices to raise an alarm.

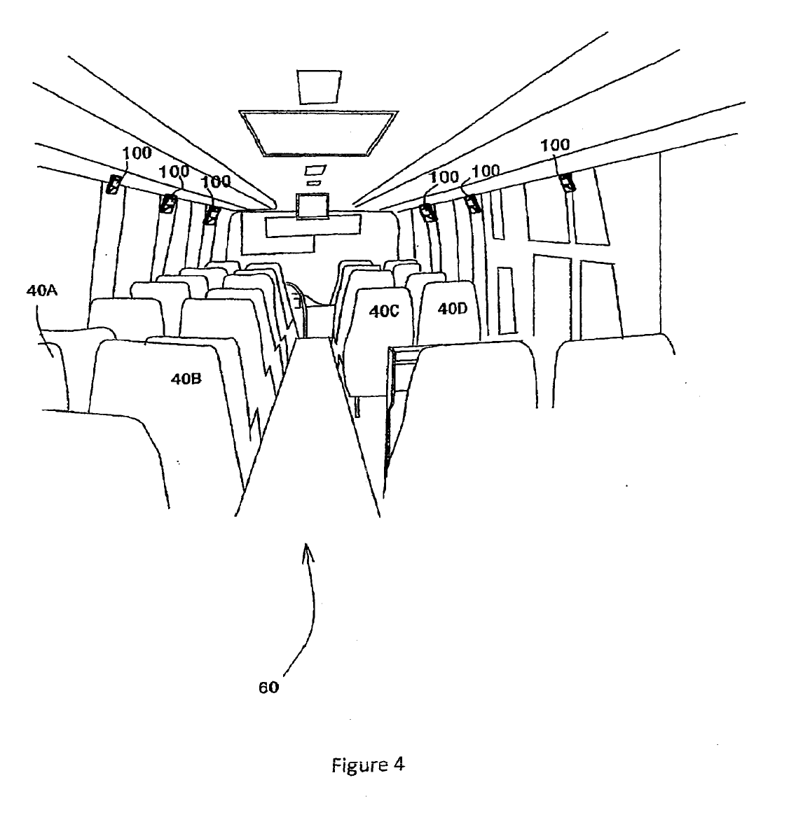

Persons skilled in the art will appreciate that the alarm system 18 may be used in vehicles other than a car 6 including a bus, a truck, a taxi, a coach, a minicab etc. For example, FIG. 4 illustrates an embodiment of the alarm system 18 for a bus 60. As illustrated in the figure, the embodiment may include a plurality of trigger sensors 100, each trigger sensor comprising a passive infrared detector for detecting the presence of a child in a corresponding one or two seats 40A, 40B.

It is envisaged that the alarm system 18 may prompt a user (such as a driver of the vehicle) to remove an infant from the car 6. For example, an embodiment may, upon the user opening a door of the car 6, output an audio message to remind the user that an infant may be in the car 6. In another embodiment, the alarm system 18 may also be configured to, upon receiving a safety belt signal indicating that the safety belt in the car 6 is retained by the corresponding safety belt retainer, receive an input indicating whether or not a baby capsule is in the car 6, and to prompt the user (as mentioned, by way of an audio message or some other mechanism) only when such an input is received. In a further embodiment, the alarm system 18 may prompt the user only after the motor of the car 6 is switched off. In yet another embodiment, the alarm system 18 may be additionally configured not to prompt the user, upon receiving an indication (for example, a signal indicating that a rear door of the car 6 has been opened and closed) that an infant in the infant carrier may have been safely removed.

In an exemplary process, the user may install a seat base of a baby capsule in a seat and be prompted by the alarm system 18 to provide an input to the car 6 to indicate that the seat base is retained by a safety belt and corresponding safety belt retainer (for example, through a digital user interface—such as a touch screen—of the car 6). Consequently, when the door next to the seat base is subsequently opened and closed, the car 6 registers that a baby capsule carrying an infant is in the car 6. When the presence of a baby capsule carrying an infant is registered, and when a condition is met (for example, the user subsequently switches the ignition on and then off, or a predetermined time period has elapsed), the alarm system 18 prompts the user to remove the infant from the car 6.

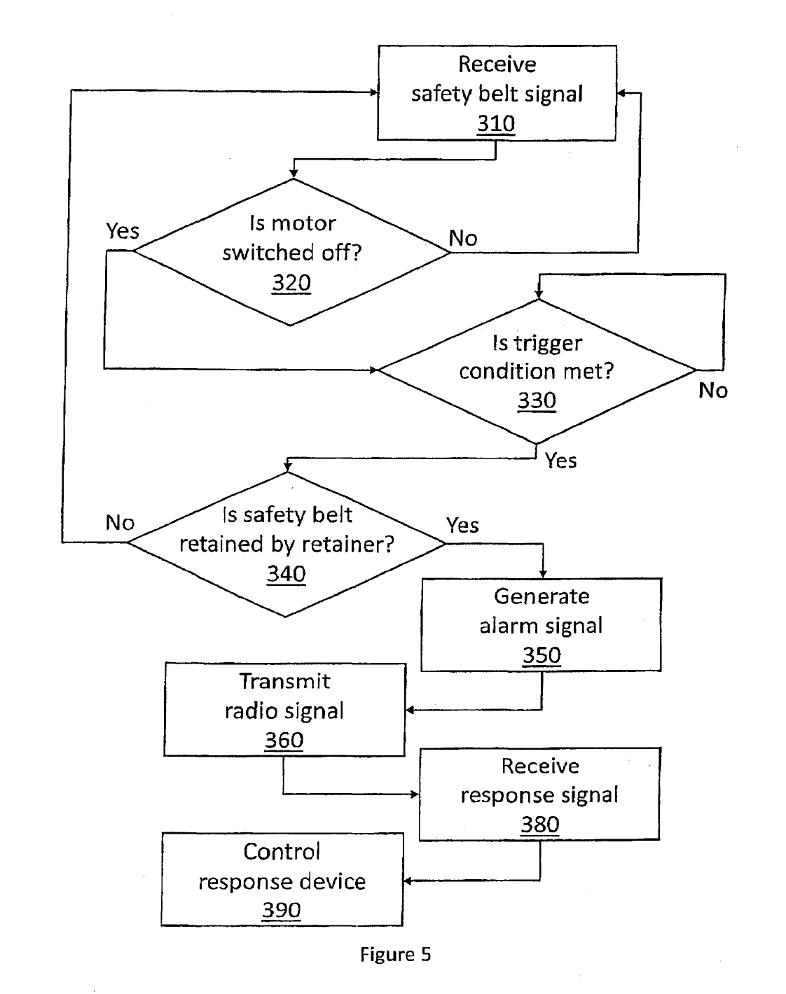

FIG. 5 is a flow chart of an embodiment of the method of generating an alarm signal, carried out using the system of FIGS. 1 to 3.

At step 328, the trigger monitor 183 of the alarm system 18 receives from the safety belt sensor 31 a safety belt signal indicating that the safety belt in the car 6 is retained by the corresponding safety belt retainer. At step 320, the trigger monitor 183 determines whether or not the motor 33 is switched off. If the trigger monitor 183 determines that the motor 33 is switched off, the trigger monitor 183 monitors the trigger sensor (that is, the passive infrared detector 28) to determine whether or not a trigger condition is met (that is, whether or not the passive infrared detector 28 detects the presence of a child in the child booster seat 2) at step 330. If the trigger monitor 183 determines that the motor 33 is not switched off, the alarm system 18 waits for another receipt of the safety belt signal.

Upon detection by the passive infrared detector 28 of the presence of a child in the child booster seat 2, the alarm generator 188 determines; using the safety belt sensor 31 whether or not the safety belt is still retained by the corresponding safety belt retainer at step 340. If the alarm generator 188 determines that the safety belt is still retained by the corresponding safety belt retainer, the alarm generator 188 generates an alarm signal in step 350. Then, at step 360, the alarm system 18 outputs the alarm signal to the response device 16 (that is, the radio transceiver 39) which in turn transmits a radio signal to the mobile phone 50 which sounds an alarm.

At step 380, the mobile phone 50 transmits a response signal to the radio transceiver 39. Upon receipt of the response signal, the alarm system 18 communicates with the car electronics system 13 to control the air conditioning system 38 to switch on and to control the central locking system 39 to unlock all of the car doors.

In an alternative embodiment, the method may not determine whether or not the motor 33 of the car 6 is switched off before monitoring the trigger sensor. Also, an alternative embodiment of the method may comprise only the trigger monitor 183 (or only the alarm generator 188) determining whether or not the safety belt is retained by the corresponding safety belt retainer. Thus, the alternative embodiment may not comprise the trigger monitor 183 receiving a safety belt signal. In such an embodiment, the trigger monitor 183 may be arranged to monitor the trigger sensor constantly, whenever the motor 33 of the car 6 is switched off, or only when the alarm system 18 is activated by a user. Also, as discussed above with respect to FIGS. 1 to 3, the trigger sensor may comprise additionally or alternatively a sensor other than a passive infrared detector. In such alternative embodiments, the trigger condition with respect to each one of the trigger sensors may be different. Finally, it is envisaged that the safety belt sensor 31 may be a sensor for a child safety belt of a child booster seat or an infant carrier rather than a safety belt of the car.

Further aspects of the method will be apparent from the above description of the gaming system. Persons skilled in the art will also appreciate that the method could be embodied in program code. The program code could be supplied in a number of ways, for example on a tangible computer readable medium, such as a disc or a memory (for example, that could replace part of the memory of the processor) or as a data signal (for example, by transmitting it from a server). For example, in the case where a touchscreen is used to deactivate the alarm so far as it responds to signals relating to the installation of a base of a baby seat (i.e. the seatbelt will always be engaged regardless of whether an infant is held in a carrier attached to the base), the system may behave in a number of different ways. In all cases the seatbelt sensor(s) will send a signal to a receiver in the car electronics system in the vehicle. From the respective signal the receiver will identify various pieces of information depending on how the system is configured. Such information may:

(i) simply identify that one or more seatbelts are engaged;

(ii) identify the number of seatbelts that are engaged; or

(iii) identify specifically which seatbelts are engaged.

For the following discussion it will be assumed that any requirements as to preconditions (e.g. a temperature in the vehicle exceeds a predetermined threshold temperature) are still imposed. However, for the purposes of clarity mention of such preconditions will largely be omitted.

In case (i), after a condition is met (such as the ignition being switched off after the vehicle makes a journey) the system may prompt the driver (e.g. through an audible alarm and/or visual display on a console screen in the vehicle) in all cases to check whether there is an infant remaining in the car. Alternatively, it may prompt the driver to check whether there is an infant in the car only when a predetermined condition has been met (e.g. a door sensor registers that a door beside the infant carrier was opened and then closed before the vehicle commenced its journey).

The receiver may also receive information coupling weight sensors with seatbelt sensors, so that it only registers that a seatbelt is not engaged, indicating same to the driver, when there is sufficient weight in the respective seat to suggest the seat is occupied. Therefore, the system may become deactivated so far as it relates to the base of the infant carrier, or may alternatively recalibrate the weight sensor to respond to a weight being in the seat that is a sufficient amount higher than the weight of the base (i.e. the weight of the base is used as the baseline for determining whether a seat is occupied, rather than the empty seat being the baseline).

In case (ii), where the system is capable of registering that more than one seatbelt is engaged, it may assume that one seatbelt is always occupied by the seat base of a baby carrier and therefore only respond, inter alia by attempting to alert the driver, when more than one seatbelt is engaged unless a precondition (e.g. the door beside the seat base of the baby carrier is opened and closed prior to commencement of a journey) is met in which case it alerts the driver to check for an infant.

In case (iii), the system may be configured to respond as usual to signals derived from all seatbelt sensors except that which relates to the seat base of the baby carrier. For the seatbelt relating to the seat base of the baby carrier the system may respond by always prompting the driver to check for a infant, or by prompting the driver to check for an infant only where a precondition (e.g. the door beside the seat base being opened and then closed prior to commencement of a journey) is met.

Many other methods for determining when the alarm system should respond (e.g. generate an alarm), when the alarm system should not respond, when it should prompt the driver to remove an infant and/or prompt the driver to inform the alarm system or car electronics system when a baby carrier seat base is retained by an engaged seatbelt (i.e. the seat base is retained even when there is no infant in a baby seat attached to the seat base), are all intended to fall within the scope of the present disclosure. To that end, the examples discussed above have been provided for illustrative purposes only.

The above description may require the system to obtain from the receiver in the vehicle at least some of the information the receiver obtains from in-built sensors in the vehicle (e.g. seatbelt sensors, weight sensors or temperature sensors in a vehicle offering climate control).

To that end, the alarm system may be coupled to one or more receivers of the car electronics system of the vehicle, the one or more receivers being configured to receive signals from one or more sensors of the vehicle.

Modifications within the scope of the invention may be readily effected by those skilled in the art. It is to be understood, therefore, that this invention is not limited to the particular embodiments described by way of example hereinabove. For example, the trigger monitor may monitor for a combination of trigger conditions to be met, the system being provided with a sensor for sensing each trigger condition (e.g. the vibration and temperature sensor combination described above).

In the claims that follow and in the preceding description of the invention, except where the context requires otherwise owing to express language or necessary implication, the word “comprise” or variations such as “comprises” or “comprising” is used in an inclusive sense, that is, to specify the presence of the stated features but not to preclude the presence or addition of further features in various embodiments of the invention.

Further, any reference made herein to prior art is not intended to imply that such prior art forms or formed a part of the common general knowledge in Australia or any other country.

1. An alarm system for a vehicle, comprising:
a trigger monitor in communication with a trigger sensor and a safety belt sensor, the trigger monitor arranged to:
receive from the safety belt sensor a safety belt signal indicating that a safety belt in the vehicle is retained by a corresponding safety belt retainer; and
upon receipt of the safety belt signal, monitor the trigger sensor to determine whether or not a trigger condition is met with respect to the trigger sensor; and
an alarm generator in communication with the trigger monitor, the alarm generator arranged to generate an alarm signal upon a determination by the trigger monitor that the trigger condition is met,
wherein the safety belt sensor is connected to an electronics system of the vehicle.

2. A system as claimed in claim 1, wherein the alarm generator is in communication with the safety belt sensor, and is arranged to:
upon a determination by the trigger monitor that the trigger condition is met, determine whether or not the safety belt is still retained by the safety belt retainer using the safety belt sensor; and
generate an alarm signal only upon a determination that the safety belt is still retained by the corresponding safety belt retainer.

3. An alarm system for a vehicle, comprising;
a trigger monitor operable to monitor a trigger sensor to determine whether or not a trigger condition is met with respect to the trigger sensor; and
an alarm generator operable to generate an alarm signal;
the alarm system arranged to:
cause the trigger monitor to monitor the trigger sensor to determine whether or not the trigger condition is met with respect to the trigger sensor;
upon a determination by the trigger monitor that the trigger condition is met, determine using a safety belt sensor whether or not a safety belt in the vehicle is retained by a corresponding safety belt retainer; and
cause the alarm generator to generate an alarm signal upon a determination that the safety belt is retained by the corresponding safety belt retainer,
wherein the safety belt sensor is connected to an electronics system of the vehicle.

4. A method of generating an alarm signal for a vehicle, the method comprising:
receiving from a safety belt sensor a safety belt signal indicating that a safety belt in the vehicle is retained by a corresponding safety belt retainer;
upon receipt of the safety belt signal, monitoring a trigger sensor to determine whether or not a trigger condition is met with respect to the trigger sensor; and
generating an alarm signal upon a determination that the trigger condition is met,
wherein the safety belt sensor is connected to an electronics system of the vehicle.

5. A method of generating an alarm for a vehicle, the method comprising:
monitoring a trigger sensor to determine whether or not a trigger condition is met with respect to a trigger sensor; and
upon a determination by the trigger monitor that the trigger condition is met, determining using a safety belt sensor whether or not a safety belt in the vehicle is retained by a corresponding safety belt retainer; and
generating an alarm signal upon a determination that the safety belt is retained by the corresponding safety belt retainer,
wherein the safety belt sensor is connected to an electronics system of the vehicle.
